(19) United States
(12) Patent Application Publication
(10) Pub. No.: US 2026/0295735 A1
(43) Pub. Date: Oct. 1, 2026

(54) METHOD AND APPARATUS FOR NOTCHING

(71) Applicant: SK On Co., Ltd., Seoul (KR)

(72) Inventor: Joon Ho BAE, Daejeon (KR)

(21) Appl. No.: 19/567,309

(22) Filed: Mar. 16, 2026

(30) Foreign Application Priority Data
Mar. 28, 2025 (KR) 10-2025-0040531
Sep. 5, 2025 (KR) 10-2025-0126815

(51) Int. Cl. B23K 26/38

(52) U.S. Cl. CPC B23K 26/38

(57) ABSTRACT

In some implementations, a notching apparatus includes a first laser generator configured to cut a part of an electrode film, a sensor unit configured to detect whether fusion residues are generated on the electrode film, a second laser generator configured to remove the fusion residues, and a control unit configured to control the second laser generator based on a detection result of the sensor unit.

### CROSS-REFERENCE TO RELATED APPLICATION(S)

This patent document claims the priority and benefits of Korean Patent Application No. 10-2025-0040531 filed on Mar. 28, 2025, and Korean Patent Application No. 10-2025-0126815 filed on Sep. 5, 2025, the disclosures of which are incorporated herein by reference in its entirety.

### TECHNICAL FIELD

The disclosure and implementations disclosed in this patent document generally relate to a method and apparatus for notching.

### BACKGROUND

Secondary batteries are a type of energy storage device capable of being charged and discharged. Secondary batteries are widely used in various applications that use electricity as a power source. For example, secondary batteries are utilized as energy storage devices in various devices ranging from small devices such as mobile phones, laptops, and tablets to large devices such as vehicles and aircraft. In particular, secondary batteries have been recently actively sought to be utilized as vehicle power sources.

Secondary batteries may be classified into lead acid batteries, nickel cadmium batteries, nickel hydride batteries, lithium-ion batteries, etc., according to an electrode material, etc. Secondary batteries of each type may be appropriately selected according to design capacity, usage environment, etc. Lithium-ion batteries may implement relatively high voltage and capacity compared to other types of secondary batteries. Accordingly, lithium-ion batteries are widely used in fields requiring high-density energy storage devices, such as vehicle battery packs.

The above description is provided to facilitate understanding of the technical background of the present disclosure and should not be interpreted for the purpose of narrowing, confining, or limiting the technical idea of the present disclosure. In addition, the contents described or implied above do not necessarily mean the prior art, and some may include contents that do not correspond to the prior art.

### SUMMARY

The present disclosure may be implemented in some embodiments to provide a method and apparatus for notching that may effectively remove fusion residues generated in a laser notching process.

A secondary battery of the present disclosure may be widely applied to green technology fields such as electric vehicles, battery charging stations, solar and wind power generation using batteries, etc. In addition, the secondary battery of present disclosure may be used in eco-friendly electric vehicles, hybrid vehicles, etc. to prevent climate change by suppressing air pollution and greenhouse gas emissions.

In some embodiments of the present disclosure, a notching apparatus includes a first laser generator configured to cut a part of an electrode film, a sensor unit configured to detect whether fusion residues are generated on the electrode film, a second laser generator configured to remove the fusion residues, and a control unit configured to control the second laser generator based on a detection result of the sensor unit.

According to an embodiment, the notching apparatus may further include a laser driving unit configured to adjust a laser emission position and emission angle of the second laser generator.

According to an embodiment, the control unit may control the laser driving unit based on the detection result of the sensor unit to adjust the emission position and emission angle of the second laser generator so as to remove the fusion residues.

According to an embodiment, the sensor unit may include a first sensor and a second sensor configured to detect the fusion residues, the first sensor may be disposed above the electrode film to detect the fusion residues, and the second sensor may be disposed in a lateral direction perpendicular to a transport direction of the electrode film to detect the fusion residues.

According to an embodiment, the sensor unit may further include a third sensor, and the third sensor may detect the fusion residues in a direction different from a detection direction of the first sensor and a detection direction of the second sensor.

According to an embodiment, an angle formed by a detection direction of the third sensor and the detection direction of the first sensor or the detection direction of the second sensor may be 30° or more and 60° or less.

According to an embodiment, the sensor unit may further include a light emitting unit configured to irradiate light toward a cut surface of the electrode film.

According to an embodiment, the notching apparatus may further include a supply unit configured to supply the electrode film, and a recovery unit configured to recover the electrode film partially cut by the first laser generator.

According to an embodiment, the first laser generator may be disposed closer to the supply unit than the second laser generator, and the sensor unit may be disposed between the first laser generator and the second laser generator.

In some embodiments of the present disclosure, a notching method includes cutting an electrode film with a first laser generator, detecting whether fusion residues are generated, and removing the fusion residues with a second laser generator.

According to an embodiment, the detecting of whether the fusion residues are generated may include detecting height and protruding shape of the fusion residues.

According to an embodiment, the removing of the fusion residues with the second laser generator may include determining a method of removing the fusion residues according to the height and the protruding shape of the fusion residues.

### BRIEF DESCRIPTION OF DRAWINGS

Certain aspects, features, and advantages of the present disclosure are illustrated by the following detailed description with reference to the accompanying drawings.

FIG. 1 is a schematic diagram of a notching apparatus according to an embodiment of the present disclosure;

FIG. 2 is a block diagram of a notching apparatus according to an embodiment of the present disclosure;

FIGS. 3A, 3B, and 3C are diagrams illustrating examples of a process of removing fusion residues generated in a notching process;

FIG. 4 is a diagram illustrating an example of a sensor unit according to an embodiment of the present disclosure;

FIGS. 5A and 5B are diagrams illustrating examples of the arrangement of a sensor unit according to an embodiment of the present disclosure; and

FIG. 6 is a flowchart of a notching method according to an embodiment of the present disclosure.

### DETAILED DESCRIPTION

Features of the present disclosure disclosed in this patent document are described by example embodiments with reference to the accompanying drawings.

The present disclosure may be implemented in some embodiments to provide a method and apparatus for notching.

Prior to the detailed description of the present disclosure, terms and words used in the specification and claims should not be interpreted as being limited to their common or dictionary meanings, and should be interpreted based on meanings and concepts consistent with the technical spirit of the present disclosure, under the principle that the inventors may appropriately define the concepts of terms to explain their invention in the best possible way. Therefore, the embodiments described in the present specification and the configurations shown in the drawings are merely the most preferred embodiments of the present disclosure, and do not represent all of the technical spirit of the present disclosure, and thus, it should be understood that there may be various equivalents and modifications capable of replacing them at the time of filing the present application.

Hereinafter, preferred embodiments of the present disclosure will be described in detail with reference to the accompanying drawings. In this regard, it should be noted that in the accompanying drawings, the same components are denoted by the same reference numerals as much as possible. In addition, detailed descriptions of well-known functions and configurations that may obscure the gist of the present disclosure will be omitted. For the same reason, some components in the accompanying drawings are exaggerated, omitted, or schematically illustrated, and the size of each component does not entirely reflect its actual size. For example, expressions such as upper side, upper portion, upward, lower side, lower portion, downward, and side surface are described based on the illustrations in the drawings, and may be expressed differently when the direction of the corresponding object is changed.

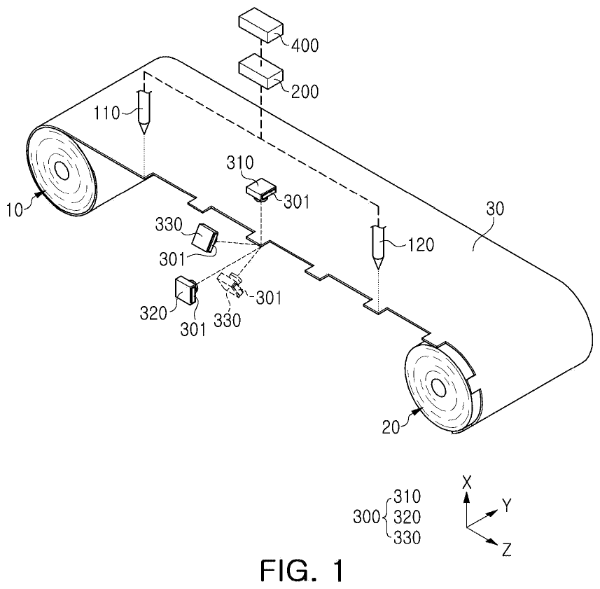

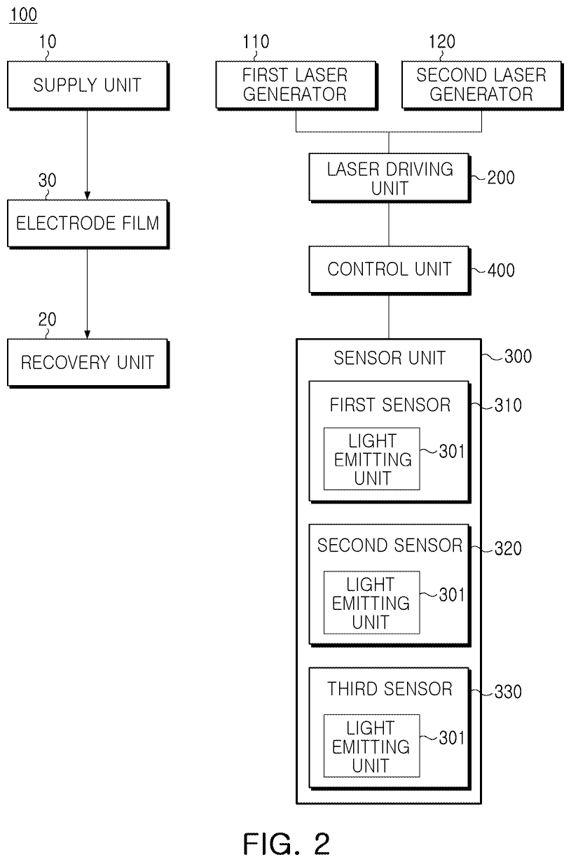

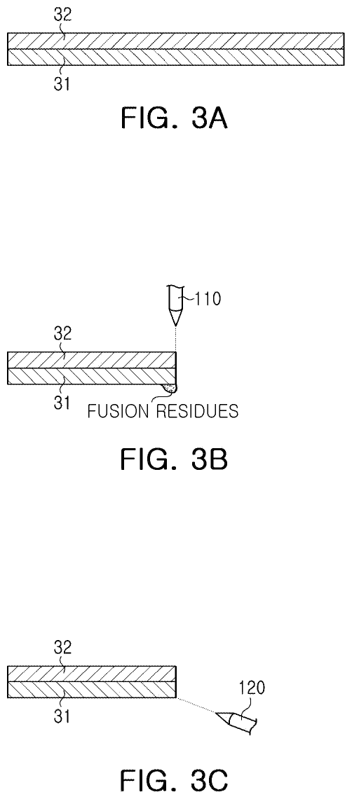

FIG. 1 is a schematic diagram of a notching apparatus 100 according to an embodiment of the present disclosure. FIG. 2 is a block diagram of the notching apparatus 100 according to an embodiment of the present disclosure. FIGS. 3A, 3B, and 3C are diagrams illustrating examples of a process of removing fusion residues generated in a notching process.

Referring to FIG. 1, the notching apparatus 100 according to an embodiment of the present disclosure may include a supply unit 10 and a recovery unit 20 of an electrode film 30.

The supply unit 10 may be a configuration to supply the electrode film 30 that is wound, and the recovery unit 20 may be a configuration to transfer and wind the electrode film 30 that is supplied from the supply unit 10 and notched.

In other words, the notching apparatus 100 according to an embodiment of the present disclosure may include the supply unit 10 for supplying the electrode film 30 and the recovery unit 20 for recovering the electrode film 30 partially cut by a first laser generator 110.

Referring to FIG. 1, the electrode film 30 is illustrated as being transferred in a roll-to-roll method, but the present disclosure is not limited thereto, and may be similarly applied to a case where the electrode film 30 is transferred in a roll-to-sheet method.

The supply unit 10 and the recovery unit 20 are non-essential configurations of the present disclosure, and detailed descriptions thereof may be omitted.

The notching apparatus 100 according to an embodiment of the present disclosure may include the first laser generator 110 for cutting the electrode film 30, a sensor unit 300 for detecting whether fusion residues of the electrode film 30 are generated, a second laser generator 120 for removing the fusion residues, and a control unit 400 for controlling the second laser generator 120 based on a detection result of the sensor unit 300.

Here, the first laser generator 110 may be disposed closer to the supply unit 10 than the second laser generator 120, and the sensor unit 300 may be disposed between the first laser generator 110 and the second laser generator 120.

The first laser generator 110 may cut the electrode film 30 to form a notching.

Referring to FIG. 1, the first laser generator 110 may be provided between the supply unit 10 and the recovery unit 20 of the electrode film 30 transferred in the roll-to-roll method, and may be a laser that cuts the electrode film 30 by irradiating a laser beam to the electrode film 30. In addition, the beam quality, output, and pulse conditions of the first laser generator 110 may be optimized according to the material (e.g., Al, Cu) and thickness of the electrode film 30.

However, in a process for the first laser generator 110 to cut the electrode film 30, an active material 32 and a foil 31 of the electrode film 30 may be melted by laser energy, and as the melt re-solidifies, fusion residues (e.g., dross and burrs) may be generated.

The sensor unit 300 may detect whether fusion residues are generated on a cut surface of the electrode film 30.

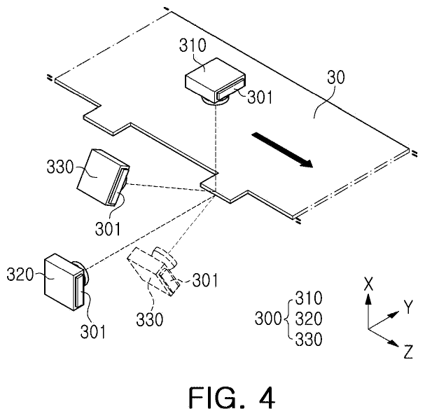

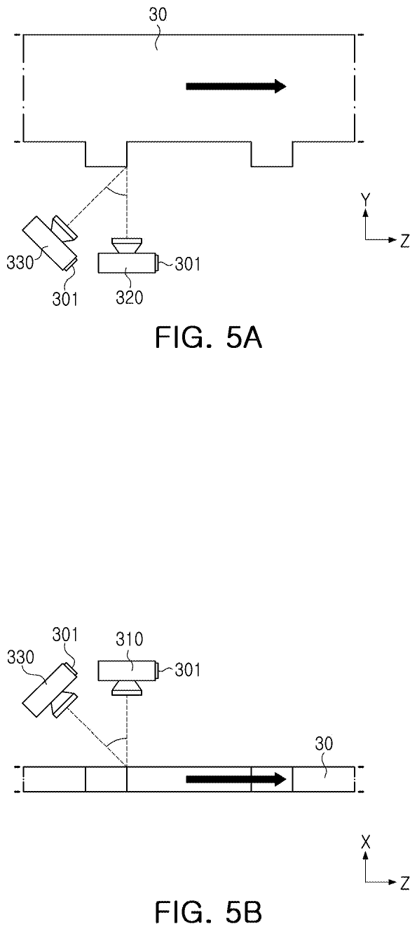

FIG. 4 is a diagram illustrating an example of the sensor unit 300 according to an embodiment of the present disclosure. FIGS. 5A and 5B are diagrams illustrating examples of the arrangement of the sensor unit 300 according to an embodiment of the present disclosure.

Referring to FIGS. 4 and 5, the sensor unit 300 may include a first sensor 310 and a second sensor 320 for detecting fusion residues, the first sensor 310 may be disposed above the electrode film 30 to detect fusion residues, and the second sensor 320 may be disposed on a side of the electrode film 30 to detect fusion residues.

Referring to FIG. 4, the sensor unit 300 may be a camera including a lens.

The sensor unit 300 may include the first sensor 310 for inspecting an upper surface of the electrode film 30 and the second sensor 320 for side inspection to detect fusion residues in multiple directions.

The first sensor 310 may be disposed above the electrode film 30 to detect whether fusion residues on a cut surface are generated in a direction perpendicular to the upper surface of the electrode film 30.

A general macro lens may be applied to the first sensor 310 to secure a wide field of view. Accordingly, it is possible to quickly and efficiently inspect the upper surface of the electrode film 30.

In addition, the second sensor 320 may detect whether fusion residues on the cut surface are generated in a lateral direction of the electrode film 30, perpendicular to a transport direction of the electrode film 30.

A high-resolution macro lens may be applied to the second sensor 320 to detect a relatively narrow side surface of the electrode film 30.

The sensor unit 300 may further include a light emitting unit 301 to irradiate light toward the cut surface of the electrode film 30.

The light emitting unit 301 may be an LED light. The light emitting unit 301 may help the sensor unit 300 to more reliably detect fusion residues by illuminating the electrode film 30 to be inspected.

In particular, the light emitting unit 301 may be disposed to irradiate light in the same direction as a detection direction of the sensor unit 300, such that the sensor unit 300 may detect fusion residues more effectively.

The sensor unit 300 according to an embodiment of the present disclosure may further include a third sensor 330, and the third sensor 330 may detect fusion residues in a direction different from a detection direction of the first sensor 310 and a detection direction of the second sensor 320.

A detection direction of the third sensor 330 may form a predetermined angle with the detection direction of the first sensor 310, that is, a line perpendicular to the upper surface of the electrode film 30.

In addition, the detection direction of the third sensor 330 may form an angle with the detection direction of the second sensor 320, that is, the lateral direction perpendicular to the transport direction of the electrode film 30.

FIG. 5A is a schematic diagram of FIG. 4 viewed from the upper surface (X-axis direction) of the electrode film 30, and FIG. 5B is a schematic diagram of FIG. 4 viewed from the side surface (Y-axis direction) of the electrode film 30.

Referring to FIG. 5A, the third sensor 330 may form a predetermined angle with a monitoring direction of the second sensor 320 and may be disposed to monitor the electrode film 30. In addition, referring to FIG. 5B, the third sensor 330 may form a predetermined angle with a monitoring direction of the first sensor 310 and may be disposed to monitor the electrode film 30.

Here, FIG. 5B shows that the third sensor 330 is disposed on the upper surface of the electrode film 30, but the present disclosure is not limited thereto, and the third sensor 330 may be disposed on a lower surface of the electrode film 30.

That is, the third sensor 330 may form a predetermined angle with a plane (X-Y plane) on which the first sensor 310 and the second sensor 320 are disposed, and may monitor the electrode film 30.

Here, the angle formed by the detection direction of the third sensor 330 and the detection direction of the first sensor 310 or the detection direction of the second sensor 320 may be 30° or more and 60° or less. Preferably, the angle formed by the detection direction of the third sensor 330 and the detection direction of the first sensor 310 or the detection direction of the second sensor 320 may be approximately 45°.

The third sensor 330 may be provided to form the predetermined angle with the first sensor 310 and the second sensor 320, thereby detecting the protrusion height and slope of fusion residues by using triangulation, and detecting the fusion residues of the electrode film 30 moving without a blind spot.

Meanwhile, the sensor unit 300 may be a laser displacement sensor or a 3D scanner. The laser displacement sensor may detect a change in the height of a cut surface or protruding fusion residues by measuring a distance to an object by using a laser. In addition, the 3D scanner may reconstruct the overall three-dimensional shape of the cut surface to accurately determine whether fusion residues are present and the size of fusion residues.

Referring back to FIGS. 1 and 2, the notching apparatus 100 according to an embodiment of the present disclosure may further include a laser driving unit 200 that may adjust a laser emission position and emission angle of the second laser generator 120.

The control unit 400 may control the laser driving unit 200 based on the detection result of the sensor unit 300 to adjust the emission position and emission angle of the second laser generator 120 so as to remove the fusion residues.

For example, the laser driving unit 200 may be configured as a robot arm or a mechanical actuator, and may change the angle of the second laser generator 120 according to a command from the control unit 400 to be described below. That is, the laser driving unit 200 may be a robot arm having several joints, may be a ball screw connected to a tilt and a rotation unit, or may be a piezo actuator, etc.

The laser driving unit 200 may change the position and angle of the second laser generator 120, may irradiate the second laser generator 120 in a vertical direction to remove upper surface residues, or may irradiate the second laser generator 120 in a horizontal or inclined direction to remove side residues.

The control unit 400 may be implemented through a nonvolatile memory (not shown) configured to store an algorithm configured to control operations of various components of the first laser generator 110, the second laser generator 120, and the laser driving unit 200 or data regarding software instructions for reproducing the algorithm and a processor (not shown) configured to perform operations described below by using the data stored in the corresponding memory.

Here, the memory and the processor may be implemented as individual chips. Alternatively, the memory and processor may be implemented as a single chip integrated with each other. The processor may take the form of one or more processors.

The control unit 400 may control the second laser generator 120 based on the detection result of the sensor unit 300. The control unit 400 may analyze data transmitted in real time from the sensor unit 300 to identify the location and amount of fusion residues that have been generated.

Based on the detection result of the sensor unit 300, the control unit 400 may control the laser driving unit 200, and control the laser driving unit 200 to move the second laser generator 120 to an appropriate position to remove the fusion residues.

In addition, the control unit 400 may variably control the output, position, and angle of the second laser generator 120 to determine the optimal conditions for removing the fusion residues.

Referring to FIG. 3A, the electrode film 30 may include the foil 31 formed of a metal material such as aluminum, and the electrode active material 32 disposed on at least one of both surfaces of the foil 31.

Referring to FIG. 3B, the electrode film 30 may be notched by the first laser generator 110. In this process, the electrode film 30 may be melted by the energy of the first laser generator 110 to generate fusion residues.

Here, the fusion residues may include molten materials that protrude around the cut surface and harden, or that harden and adhere to lower parts due to gravity. The fusion residues generated on the electrode film 30 may cause product defects in subsequent processes.

Referring to FIG. 3C, in the notching apparatus 100 according to an embodiment of the present disclosure, the sensor unit 300 may continuously detect whether fusion residues are generated by the first laser generator 110. In addition, when it is detected by the sensor unit 300 that the fusion residues have been generated, the control unit 400 may remove the fusion residues by using the second laser generator 120.

Here, methods of removing the fusion residues by using the second laser generator 120 may include a method of using re-melting and a cutting and evaporation method.

In the method of using re-melting, the second laser generator 120 may irradiate low energy to the fusion residues to re-melt the residues, and allow the melted material to be uniformly adhered to the surrounding electrode film 30 again. That is, the control unit 400 may precisely control the second laser generator 120 to selectively melt and re-condense the fusion residues, and may remove unnecessarily protruding fusion residues.

In addition, in the cutting and evaporation method, the second laser generator 120 may irradiate high energy to the fusion residues to evaporate or cut the residues, and eliminate the fusion residues. The control unit 400 may remove the fusion residues without a physical removal process by instantly heating and vaporizing the residues by using the second laser generator 120, and may be effective when the amount of fusion residues is large.

Meanwhile, the control unit 400 may apply any one of the method of using re-melting and the cutting and evaporation method, or a combination thereof.

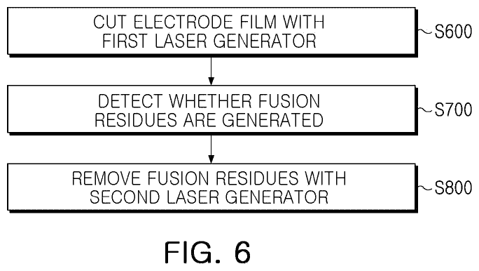

FIG. 6 is a flowchart of a notching method according to an embodiment of the present disclosure.

Referring to FIG. 6, the notching method according to an embodiment of the present disclosure may include an operation S600 of cutting the electrode film 30 with the first laser generator 110, an operation S700 of detecting whether fusion residues are generated, and an operation S800 of removing the fusion residues with the second laser generator 120.

The operation S600 of cutting the electrode film 30 with the first laser generator 110 may be an operation of cutting and notching a part of the electrode film 30 that is transferred with the first laser generator 110.

In the operation of cutting the part of the electrode film 30 with the first laser generator 110, the active material 32 and the foil 31 of the electrode film 30 may be melted by the energy of the first laser generator 110, and fusion residues may be generated as the melt re-solidifies.

Here, the fusion residues may decrease the precision of an electrode, and cause defects in subsequent processes.

The operation S700 of detecting whether the fusion residues are generated may be an operation in which the sensor unit 300 detects whether the fusion residues are generated. In particular, in the operation S700 of detecting whether the fusion residues are generated, the height and protruding shape of the fusion residues may be detected.

The sensor unit 300 according to an embodiment of the present disclosure may be disposed at a rear end of the first laser generator 110 with respect to a transfer direction of the electrode film 30, and may include a plurality of sensors disposed in different positions.

For example, the sensor unit 300 may include the first sensor 310, the second sensor 320, and the third sensor 330 disposed in different locations, and each of the first sensor 310, the second sensor 320, and the third sensor 330 may include a camera with a lens.

More specifically, the first sensor 310 may detect whether the fusion residues are generated on the upper portion of the electrode film 30, and the second sensor 320 may detect whether the fusion residues are generated on the side surface of the electrode film 30. The second sensor 320 may precisely detect the side surface of the electrode film 30 by using a high-resolution lens. In addition, the third sensor 330 may detect the fusion residues without a blind spot by detecting the fusion residues at a different angle from the first sensor 310 and the second sensor 320 and identify the height and protruding shape of the fusion residues by using triangulation.

In addition, the sensor unit 300 may further include the light emitting unit 301 to irradiate light toward a detection part.

The light emitting unit 301 may be an LED light, and may help the sensor unit 300 more reliably detect the fusion residues by illuminating the electrode film 30 to be inspected.

The operation S800 of removing the fusion residues with the second laser generator 120 may be an operation in which the control unit 400 controls the laser driving unit 200 based on a detection result in the operation S700 of detecting whether the fusion residues are generated to remove the fusion residues by adjusting the output, position, and angle of the second laser generator 120.

In addition, in the operation S800 of removing the fusion residues with the second laser generator 120, a method of removing the fusion residues according to the height and protruding shape of the fusion residues may be determined.

In the operation S800 of removing the fusion residues with the second laser generator 120, the control unit 400 may control the laser driving unit 200 based on the detection result in the operation S700 of detecting whether the fusion residues are generated to adjust the position and angle of the second laser generator 120 so as to remove the fusion residues, and remove the fusion residue by using the determined method of removing the fusion residues.

Here, methods of removing the fusion residues by using the second laser generator 120 may include a method of using re-melting and a cutting and evaporation method.

In the method of using re-melting, the second laser generator 120 may irradiate low energy to the fusion residues to re-melt the residues, and allow the melted material to be uniformly adhered to the electrode film 30 again.

That is, in the method of using re-melting, the control unit 400 may precisely control the second laser generator 120 to selectively melt and re-condense the fusion residues, and may remove unnecessarily protruding fusion residues.

In addition, in the cutting and evaporation method, the second laser generator 120 may irradiate high energy to the fusion residues to evaporate or cut the residues, and eliminate the fusion residues. The control unit 400 may remove the fusion residues without a physical removal process by instantly heating and vaporizing the residues by using the second laser generator 120, and may be effective when the amount of fusion residues is large.

Meanwhile, the operation S800 of removing the fusion residues with the second laser generator 120 may be applied to any one of the method of using re-melting and the cutting and evaporation method, or a combination thereof based on the detection result in the operation S700 of detecting whether the fusion residues are generated.

For example, when the height of the fusion residues is low or a small amount thereof is detected in the operation S700 of detecting whether the fusion residues are generated, the fusion residues may be removed in the method of using re-melting.

In addition, when the height of the fusion residues is high or a large amount thereof is detected in the operation S700 of detecting whether the fusion residues are generated, the fusion residues may be removed in the cutting and evaporation method.

In the operation S800 of removing the fusion residues with the second laser generator 120, the control unit 400 may control the output of the second laser generator 120 to re-melt the fusion residues or cut or evaporate the fusion residues to remove the fusion residues, thereby improving the notching quality of the electrode film 30.

The methods according to the present disclosure may be implemented in the form of program instructions that may be executed through various computer means and recorded in a computer-readable medium. The computer-readable medium may include program instructions, data files, data structures, etc., either alone or in combination. The program instructions recorded on the computer-readable medium may be those specifically designed and configured for the present disclosure, or may be well-known and available to those skilled in the computer software art.

Examples of the computer-readable medium include hardware devices specifically configured to store and execute program instructions, such as ROM, RAM, and flash memory. Examples of the program instructions include not only machine language codes produced by a compiler but also high-level language codes that may be executed by a computer using an interpreter, etc. The aforementioned hardware devices may be configured to operate as at least one software module to perform the operations of the present disclosure, and vice versa.

While the embodiments of the present disclosure have been described in detail above, the scope of the present disclosure is not limited thereto, and it will be apparent to those skilled in the art that various modifications and variations may be made without departing from the technical spirit of the present disclosure as set forth in the claims.

According to an embodiment of the present disclosure, electrode quality may be improved by in real time removing fusion residues generated in a laser notching process.

In addition, according to an embodiment of the present disclosure, the quality of an electrode may be improved by detecting fusion residues in multiple directions through a plurality of sensors and removing the fusion residues with a laser.

The effects of the present disclosure are not limited to those described above, and other effects not mentioned may be clearly recognized by those skilled in the art from the description above.

Only specific examples of implementations of certain embodiments are described. Variations, improvements and enhancements of the disclosed embodiments and other embodiments may be made based on the disclosure of this patent document.

What is claimed is:

1. A notching apparatus comprising:
a first laser generator configured to cut a part of an electrode film;
a sensor unit configured to detect whether fusion residues are generated on the electrode film;
a second laser generator configured to remove the fusion residues; and
a control unit configured to control the second laser generator based on a detection result of the sensor unit.

2. The notching apparatus of claim 1, further comprising: a laser driving unit configured to adjust a laser emission position and emission angle of the second laser generator.

3. The notching apparatus of claim 2, wherein
the control unit is configured to control the laser driving unit based on the detection result of the sensor unit to adjust the emission position and emission angle of the second laser generator so as to remove the fusion residues.

4. The notching apparatus of claim 1, wherein
the sensor unit includes a first sensor and a second sensor configured to detect the fusion residues,
the first sensor is disposed above the electrode film to detect the fusion residues, and the second sensor is disposed in a lateral direction perpendicular to a transport direction of the electrode film to detect the fusion residues.

5. The notching apparatus of claim 4, wherein
the sensor unit further includes a third sensor, and
the third sensor is configured to detect the fusion residues in a direction different from a detection direction of the first sensor and a detection direction of the second sensor.

6. The notching apparatus of claim 5, wherein an angle formed by a detection direction of the third sensor and the detection direction of the first sensor or the detection direction of the second sensor is 30° or more and 60° or less.

7. The notching apparatus of claim 1, wherein the sensor unit further includes a light emitting unit configured to irradiate light toward a cut surface of the electrode film.

8. The notching apparatus of claim 1, further comprising:
a supply unit configured to supply the electrode film; and
a recovery unit configured to recover the electrode film partially cut by the first laser generator.

9. The notching apparatus of claim 8, wherein
the first laser generator is disposed closer to the supply unit than the second laser generator, and
the sensor unit is disposed between the first laser generator and the second laser generator.

10. A notching method comprising:
cutting an electrode film with a first laser generator;
detecting whether fusion residues are generated; and
removing the fusion residues with a second laser generator.

11. The notching method of claim 10, wherein the detecting of whether the fusion residues are generated includes detecting height and protruding shape of the fusion residues.

12. The notching method of claim 11, wherein the removing of the fusion residues with the second laser generator includes determining a method of removing the fusion residues according to the height and the protruding shape of the fusion residues.
